(19) United States
(12) Patent Application Publication
(10) Pub. No.: US 2008/0050077 A1
(43) Pub. Date: Feb. 28, 2008

(54) Photonic Crystal Fiber

(76) Inventors: Takaharu Kinoshita, Hyogo (JP); Masatoshi Tanaka, Hyogo (JP)

Correspondence Address: Nixon Peabody, 401 9th Street, N.W., Suite 900, Washington, DC, 20004-2128, US

(21) Appl. No.: 11/628,237

(22) PCT Filed: Jun. 28, 2005
(86) PCT No.: PCT/JP05/11837

§ 371 Date: Dec. 1, 2006

(30) Foreign Application Priority Data
Jun. 30, 2004 (JP) 2004-192659

(51) Int. Cl. G02B 6/032

(52) U.S. Cl. 385/125

(57) ABSTRACT

A cladding 12 of a photonic crystal fiber 10 has first to fourth air hole layers 15 to 18 formed around a core 11 one after another in the radial direction of the fiber. In forming the fiber, assuming that air holes 12a constituting the first air hole layer 15 have a diameter d₁, at least one of air holes 12a constituting the second to fourth air hole layers 16 to 18 is formed in a smaller diameter d₂ than the diameter d₁.

### TECHNICAL FIELD

This invention relates to photonic crystal fibers and particularly relates to techniques for enhancing the performance of fibers.

### BACKGROUND ART

A photonic crystal fiber is an optical fiber in which a large number of air holes are regularly arranged around its central axis to form a region (core) for propagating incident light on the inside of a region where the air holes are arranged (see, for example, Patent Document 1).

According to such a photonic crystal fiber, if the diameter of the air holes arranged in the cladding and the distance between the air holes are appropriately selected, the zero-dispersion wavelength of incident light can be easily shifted to longer wavelengths or shorter wavelengths.

Patent Document 1: Published Japanese Patent Application No. 2002-243972

### DISCLOSURE OF THE INVENTION

Problems to Be Solved by the Invention

One of properties required for such a photonic crystal fiber is a single-mode operation over an wide wavelength range. A requirement for obtaining this property is that the fiber meets d/Λ<0.45 where d is the diameter of an air hole and Λ is the center-to-center distance (pitch) between adjacent air holes.

For example, FIG. 9 shows a photonic crystal fiber fabricated to meet the above requirement and the fiber is set at d/Λ=0.38. In this case, a single-mode operation can be realized at a short wavelength of 405 nm. However, since the value of d/Λ is small, this causes a problem that bending loss is large.

In contrast, FIG. 10 shows a photonic crystal fiber fabricated to avoid the occurrence of a bending loss and the fiber is set at d/Λ=0.63. In this case, almost no bending loss occurs. However, there is a problem that a single-mode operation cannot be realized at a short wavelength of 405 nm.

The present invention has been made in view of the foregoing points and, therefore, its object is to provide a photonic crystal fiber operable in a single mode at a short wavelength and having less bending loss.

Means to Solve the Problems

To attain the above object, in the present invention, the air holes arranged in the cladding have nonuniform diameters.

Specifically, the present invention is directed to a photonic crystal fiber photonic crystal fiber comprising a core extending in a direction of the central axis of the fiber and a cladding having a plurality of air holes arranged around the core to extend along the core, and characterized in that the plurality of cores are regularly arranged so that at least two air hole layers are formed around the core one after another in a radial direction of the fiber, and the air hole layer adjacent to the core is constituted by air holes all having the same diameter d₁ and at least one of a plurality of air holes constituting the other air hole layers is constituted by an air hole of diameter d₂ that meets d₁>d₂.

In the present invention, since the other air hole layer or layers are formed with an air hole of smaller diameter d₂ than the diameter d₁ of air holes constituting the air hole layer adjacent to the core, a fiber having various properties can be flexibly configured as compared to the case where air holes having a uniform diameter are arranged in the cladding.

Furthermore, the present invention may be characterized in that d₂/d₁<0.8 and d₁/Λ>0.45 hold where Λ is the center-to-center distance between each adjacent pair of the air holes.

More specifically, the ratio d₁/Λ denotes the void ratio of the cladding. Larger void ratios indicate greater percentages of air holes in the cladding. When the fiber meets d₁/Λ>0.45, the cladding enhances the effect of confining propagating light within the core, resulting in reduced bending loss in the cladding. In addition, when the fiber meets d₂/d₁<0.8, incident light having a short wavelength can be propagated in a single mode.

Effects of the Invention

As described above, according to the present invention, the bending loss can be reduced by the air hole layer adjacent to the fiber core and constituted by large-diameter air holes. In addition, since the other air hole layer or layers are formed to include an air hole of smaller diameter d₂ than the diameter d₁ of air holes constituting the first-mentioned air hole layer, this provides a single-mode operation of the fiber at a short wavelength.

Furthermore, according to the present invention, since the void ratio d₁/Λ of the cladding based on the diameter d₁ of air holes constituting the air hole layer adjacent to the fiber core and the center-to-center distance Λ between adjacent air holes is set at a larger value than 0.45 that is a condition for avoiding the occurrence of a bending loss, this is advantageous in reducing the bending loss. Moreover, since one or some of air holes constituting the surrounding other air hole layer or layers is constituted by an air hole of diameter d₂ that meets d₂/d₁<0.8, this easily realizes a single-mode operation of the fiber at a short wavelength.

### BRIEF DESCRIPTION OF DRAWINGS

FIG. 1 is a schematic structural diagram of a photonic crystal fiber according to Embodiment 1 of the present invention.

FIG. 2 is a diagram showing in enlarged manner the arrangement of air holes in a cladding of the photonic fiber according to Embodiment 1.

FIG. 3 is a diagram showing in enlarged manner the arrangement of air holes in a cladding of a photonic fiber according to Embodiment 2.

FIG. 4 is a diagram showing in enlarged manner the arrangement of air holes in a cladding of a photonic fiber according to Embodiment 3.

FIG. 5 is a diagram showing in enlarged manner the arrangement of air holes in a cladding of a photonic fiber according to Embodiment 4.

FIG. 6 is a graph showing the relation between wavelength of incident light and bending loss according to Inventive Example.

FIG. 7A is a plan view showing the relation between count and mode field diameter in Comparative Example 2, FIG. 7B is a cross-sectional view taken along the arrowed line X-X and FIG. 7C is a cross-sectional view taken along the arrowed line Y-Y.

FIG. 8A is a plan view showing the relation between count and mode field diameter in Inventive Example, FIG. 8B is a cross-sectional view taken along the arrowed line X-X and FIG. 8C is a cross-sectional view taken along the arrowed line Y-Y.

FIG. 9 is a diagram showing the arrangement of air holes in a cladding of a photonic fiber according to Comparative Example 1.

FIG. 10 is a diagram showing the arrangement of air holes in a cladding of a photonic fiber according to Comparative Example 2.

### EXPLANATION OF REFERENCE NUMERALS

10 photonic crystal fiber

11 core

12 cladding

12a air hole

15 first air hole layer

16 second air hole layer

### BEST MODE FOR CARRYING OUT THE INVENTION

Embodiments of the present invention will be described below in detail with reference to the drawings. The following description of the preferred embodiments is merely illustrative in nature and is not intended to limit the scope, applications and use of the invention.

### Embodiment 1

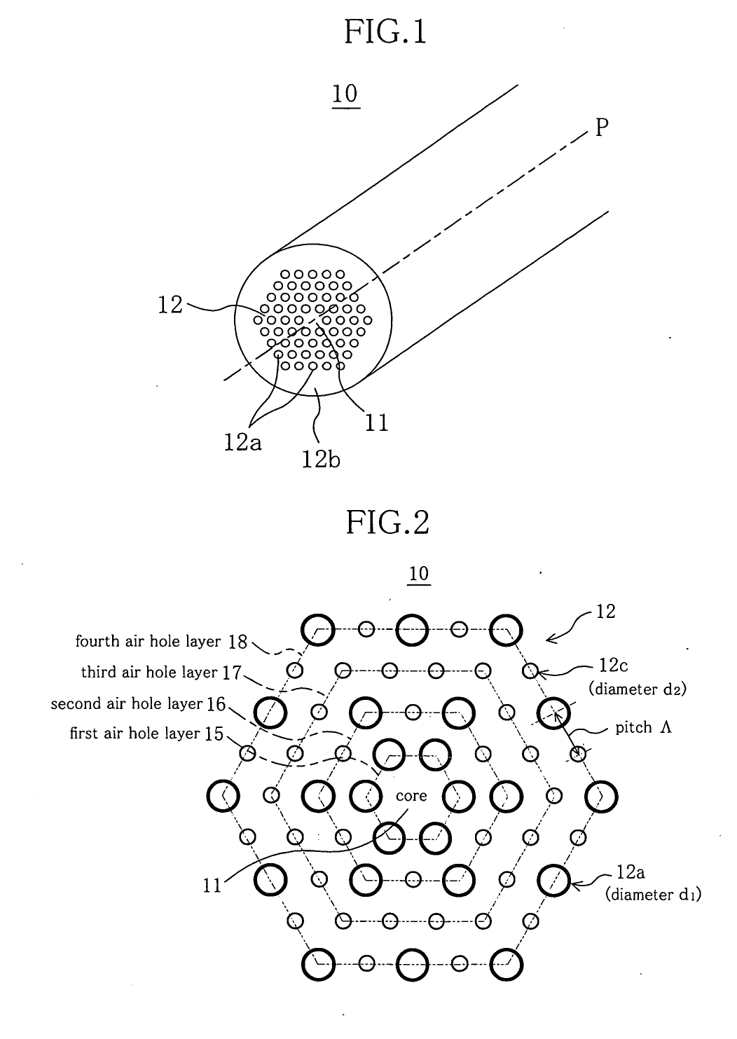

FIG. 1 is a schematic structural diagram of a photonic crystal fiber 10 (hereinafter, referred to as a PC fiber) according to Embodiment 1 of the present invention. The PC fiber 10 includes: a solid core 11 extending in the center of the fiber in the axial direction thereof, a cladding 12 having a large number of air holes 12a extending in the direction of the central axis P of the fiber and arranged regularly around the core 11; and an overcladding 12b disposed to cover the cladding 12.

Furthermore, the cladding 12 forms a photonic crystal structure in which the diffractive index changes two-dimensionally periodically. The incident light is propagated while being confined within the core 11 surrounded by the photonic crystal structure.

FIG. 2 is a diagram showing, in enlarged manner, the arrangement of the air holes 12a in the cladding 12 of the PC fiber 10 according to Embodiment 1. Specifically, in a portion of the cladding 12 radially nearest to the central axis P of the fiber, six air holes 12a, 12a, . . . are arranged to form a regular hexagon, each opposed pair arranged with the fiber central axis P interposed therebetween. The six air holes 12a, 12a, . . . constitute a substantially ring-shaped first air hole layer 15. The inner region surrounded by the first air hole layer 15 provides the core 11.

The arrangement of the air holes 12a, 12a, . . . in the cladding 12 is a periodical arrangement in which the distance between the centers of every adjacent pair of air holes 12a, 12a is the same distance Λ (pitch) and every adjacent three air holes 12a form a regular triangle. The air holes 12a, 12a, . . . are arranged around the core 11 in this periodicity. In Embodiment 1, according to this arrangement, four layers, i.e., first to fourth air hole layers 15 to 18 are formed around the core 11 in order from it in the radial direction of the fiber.

In this case, the first air hole layer 15 is constituted by air holes 12a all having a diameter d₁. Next, the second air hole layer 16 is formed so that air holes 12a of diameter d₁ and air holes 12c of smaller diameter d₂ than the diameter d₁ are alternated.

Then, the third air hole layer 17 is constituted by air holes 12c all having a diameter d₂ and the fourth air hole layer 18 is formed, like the second air hole layer 16, so that air holes 12a of diameter d₁ and air holes 12c of diameter d₂ are alternated.

As seen from the above, in the photonic crystal fiber according to Embodiment 1 of the present invention, since the air holes 12c of smaller diameter d₂ than the diameter d₁ of the air holes 12a constituting the first air hole layer 15 in the cladding 12 are formed in the second air hole layer 16 and the later air hole layers, the photonic crystal fiber can be reduced in bending loss and can operate in a single mode even with incident light having a short wavelength.

Generally used as a method of fabricating a PC fiber 10 is a capillary method in which multiple capillaries are stacked and then drawn. In the PC fiber 10 according to Embodiment 1 of the present invention, the center-to-center distance between every adjacent air holes 12a, 12a is set at a specified distance Λ. Therefore, a PC fiber 10 achieving a very accurate and regular air hole arrangement can be obtained by fabrication using a capillary method in which two types of capillaries having the same outer diameter but different inner diameters are arranged.

### Embodiment 2

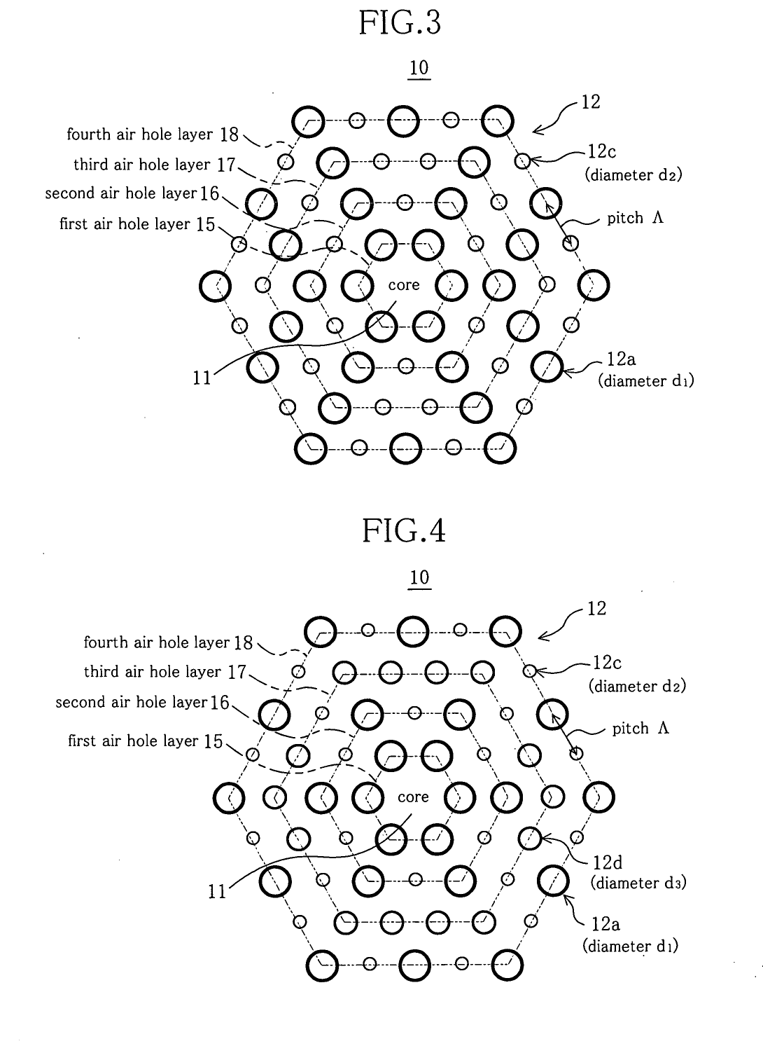

FIG. 3 is a photonic crystal fiber 10 according to Embodiment 2 of the present invention. The difference of Embodiment 2 from Embodiment 1 lies only in the arrangement of air holes with different diameters. Therefore, like parts as in Embodiment 1 are identified by the same reference numerals and a description of Embodiment 2 is given only of the difference (the same applies to Embodiments 3 and 4).

First, the diameters and arrangement of air holes in the first, second and fourth air hole layers 15, 16 and 18 are the same as in Embodiment 1. Therefore, a description thereof is not given.

The third air hole layer 17 is formed, like the second air hole layer 16, so that air holes 12a of diameter d₁ and air holes 12c of diameter d₂ are substantially alternated.

Therefore, also according to Embodiment 2, the same behaviors and effects as in Embodiment 1 can be obtained.

### Embodiment 3

FIG. 4 is a photonic crystal fiber 10 according to Embodiment 3 of the present invention. The difference of Embodiment 3 from Embodiments 1 and 2 lies only in the arrangement of air holes with different diameters.

First, the diameters and arrangement of air holes in the first, second and fourth air hole layers 15, 16 and 18 are the same as in Embodiments 1 and 2. Therefore, a description thereof is not given.

The third air hole layer 17 is formed so that air holes 12d of diameter d₃ are arranged in plural groups, each group constituted by a sequence of plural air holes, and a single air hole 12c of diameter d₂ lies between each adjacent pair of the groups of air holes 12d, where d₃ is the diameter of air holes 12d smaller than the diameter d₁ of air holes 12a in the first air hole layer 15 and larger than the diameter d₂ of air holes 12c.

Therefore, also according to Embodiment 3, the same behaviors and effects as in Embodiment 1 can be obtained.

### Embodiment 4

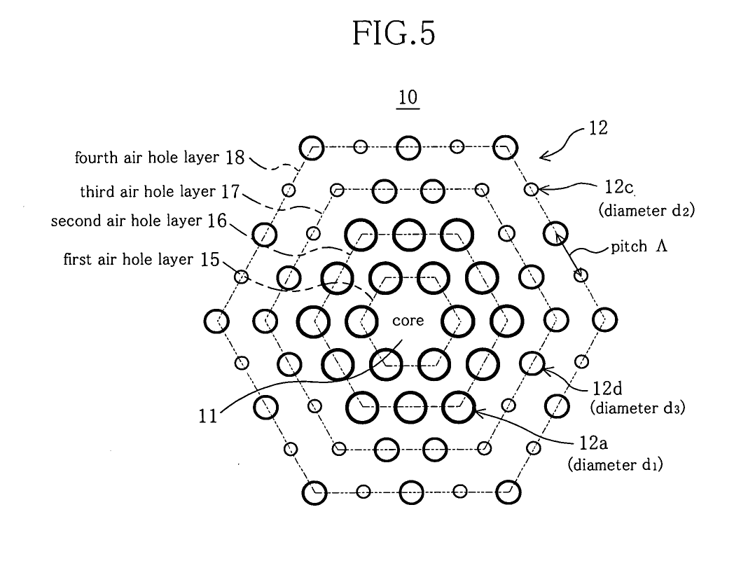

FIG. 5 is a photonic crystal fiber 10 according to Embodiment 4 of the present invention. The difference of Embodiment 4 from Embodiments 1 to 3 lies only in the arrangement of air holes with different diameters.

In this case, the first air hole layer 15 and the second air hole layer 16 are each constituted only by air holes 12a of diameter d₁.

The third air hole layer 17 is formed so that air holes 12d of diameter d₃ are arranged in plural groups, each group constituted by a sequence of plural air holes, and two air holes 12c of diameter d₂ lie between each adjacent pair of the groups of air holes 12d.

The fourth air hole layer 18 is formed so that air holes 12c of diameter d₂ and air holes 12d of diameter d₃ are alternated.

Therefore, also according to Embodiment 4, the same behaviors and effects as in Embodiment 1 can be obtained.

Note that the arrangements of air holes of different diameters shown in Embodiments 1 to 4 are illustrative only and various other arrangements are also applicable.

### EXAMPLE

Next, a description is given of Inventive Example particularly carried out. A photonic crystal fiber used in Inventive Example has the same structure as in Embodiment 1, the fiber diameter is 125 μm, the core diameter is 9 μm, the diameter d₁ of air hole is 4.2 [μm], the diameter d₂ of air hole smaller than the diameter d₁ is 2.0 [μm] and the center-to-center distance Λ between adjacent air holes is 6.5 [μm]. Thus, the equations d₂/d₁=0.48, d1/Λ=0.65 and d₂/Λ=0.31 are given.

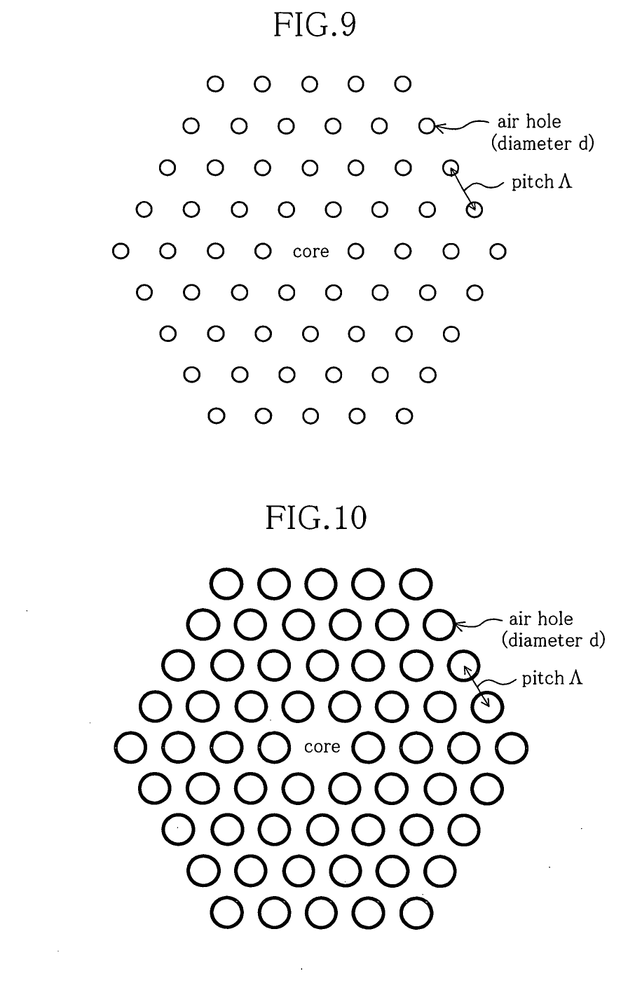

An experiment was carried out using also a PC fiber of d/Λ=0.38 shown in FIG. 9 and a PC fiber of d/Λ=0.63 shown in FIG. 10 as Comparative Examples 1 and 2, respectively, in order to ascertain the performance of the PCV fiber of Inventive Example.

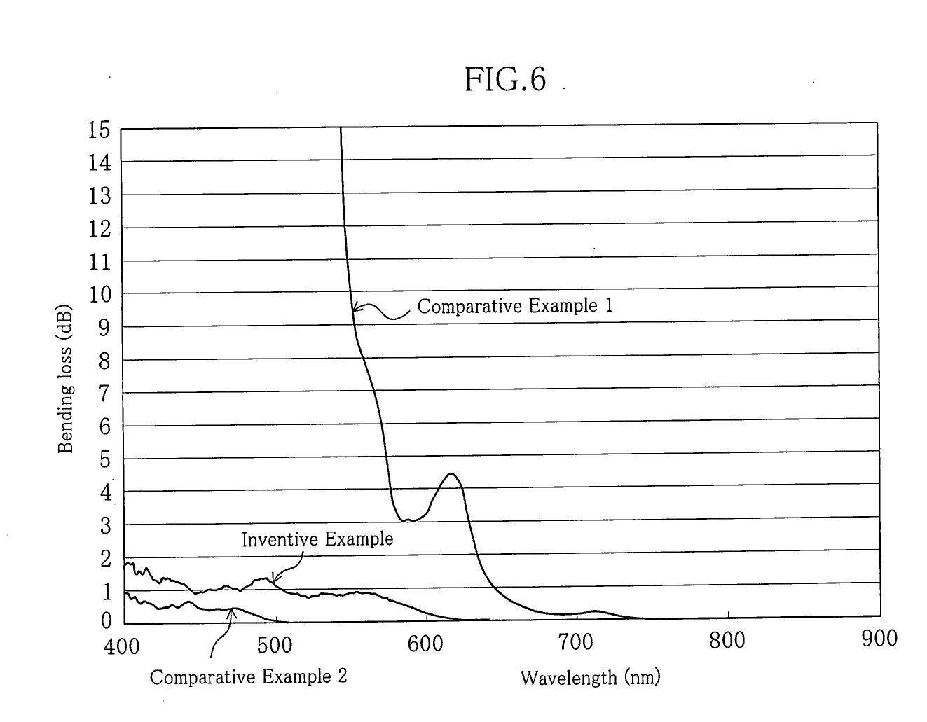

First, in order to determine the relation between wavelength of incident light and bending loss, each of the above PC fibers 10 was coiled into ten turns with a bending diameter of 60 mm and, in this state, measured in terms of power variations. The results are shown in FIG. 6.

By reference to FIG. 6, it could be ascertained that the fibers of Comparative Example 2 and Inventive Example exhibited small bending losses and the fiber of Comparative Example 1 exhibited a large bending loss.

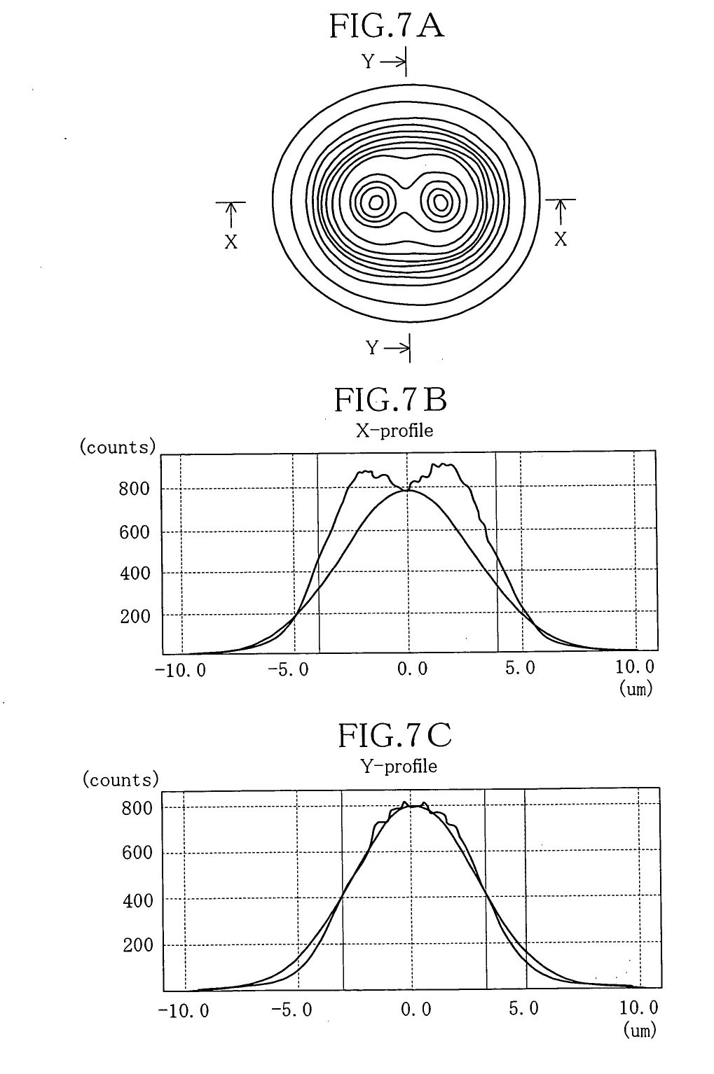

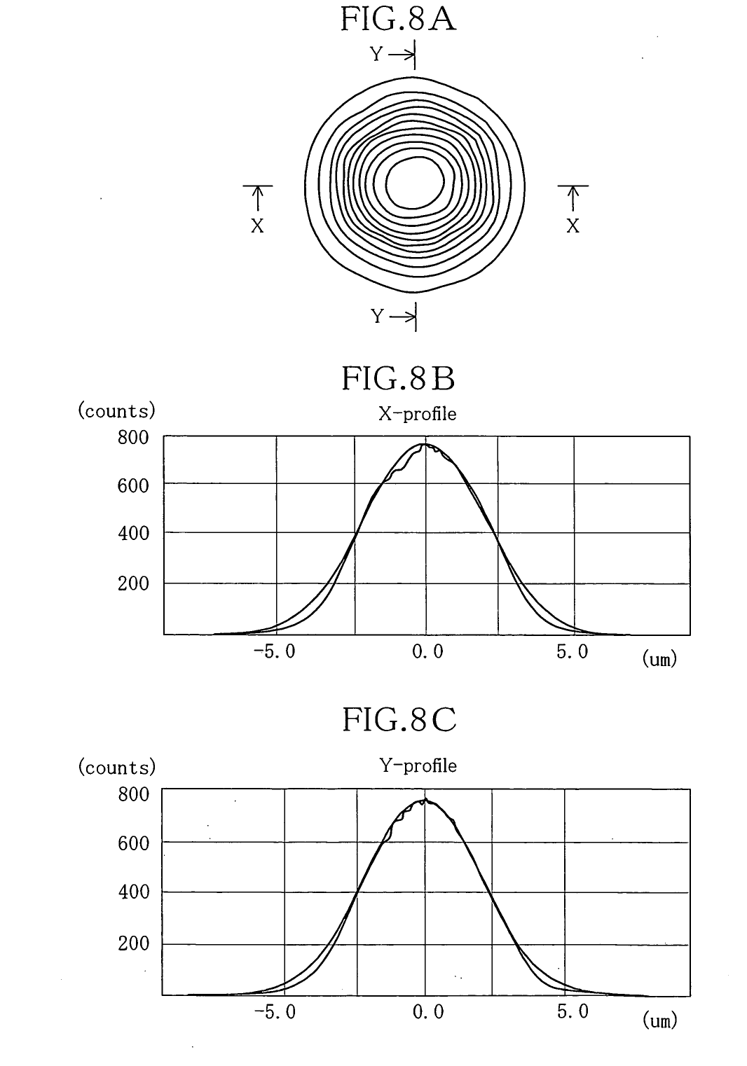

Next, the small-bending-loss PC fibers used in Comparative Example 2 and Inventive Example were checked for whether they can operate in a single mode. The results are shown in FIGS. 7 and 8.

FIG. 7A is a plan view in which the relation between count and mode field diameter in Comparative Example 2 analyzed by simulation was drawn. FIG. 7B is a cross-sectional view take along the arrowed line X-X and FIG. 7C is a cross-sectional view take along the arrowed line Y-Y.

It could be ascertained from the above results that in Comparative Example 2, two peaks appeared because of existence of a second mode and, therefore, the fiber cannot operate in a single mode.

FIG. 8A is a plan view in which the relation between count and mode field diameter in Inventive Example analyzed by simulation was drawn. FIG. 8B is a cross-sectional view take along the arrowed line X-X and FIG. 8C is a cross-sectional view take along the arrowed line Y-Y.

It could be ascertained from the above results that in Inventive Example, a single peak appeared and, therefore, the fiber can operate in a single mode.

### INDUSTRIAL APPLICABILITY

As described so far, the present invention provides a photonic crystal fiber having a highly practical effect of realizing a single-mode operation even at a short wavelength while reducing the bending loss and, therefore, is extremely useful and high in industrial applicability.

1. A photonic crystal fiber comprising a core extending in a direction of the central axis of the fiber and a cladding having a plurality of air holes arranged around the core to extend along the core, wherein
the plurality of cores are regularly arranged so that at least two air hole layers are formed around the core one after another in a radial direction of the fiber, and
the air hole layer adjacent to the core is constituted by air holes all having the same diameter d₁ and at least one of a plurality of air holes constituting the other air hole layers is constituted by an air hole of diameter d₂ that meets d₁>d₂.

2. The photonic crystal fiber of claim 1, wherein d₂/d₁<0.8 and d₁/Λ>0.45 hold where Λ is the center-to-center distance between each adjacent pair of the air holes.
